(19) United States
(12) Patent Application Publication
(10) Pub. No.: US 2025/0297662 A1
(43) Pub. Date: Sep. 25, 2025

(54) END FITTING FOR GAS SPRING

(71) Applicant: Austin Hardware & Supply, Inc., Lee's Summit, MO (US)

(72) Inventors: Robert Walden, Buford, GA (US); Moises Beltran, JR., Buford, GA (US)

(21) Appl. No.: 19/079,886

(22) Filed: Mar. 14, 2025

Related U.S. Application Data
(60) Provisional application No. 63/567,604, filed on Mar. 20, 2024.

(51) Int. Cl. F16F 9/02

(52) U.S. Cl. CPC F16F 9/0281

(57) ABSTRACT

An end fitting for a gas spring is described. The end fitting includes a fitting body. The fitting body includes a socket opening, a shaft opening, and a compartment. The end fitting includes a spring. The spring is engaged to the fitting body. Ends of the spring hold a ball connector in a ball and socket fashion. The end fitting includes a release lever. The release lever is rotatably engaged to the fitting body and moves the ends of the spring to hold or release the ball connector. The end fitting includes a threaded insert that is positioned in the compartment. The end fitting receives a threaded connection from the gas spring.

The present application claims priority to U.S. Provisional Patent Application No. 63/567,604 filed Mar. 20, 2024, which is hereby incorporated by reference.

### FIELD OF INVENTION

The present invention relates to an end fitting for a gas spring.

### BACKGROUND OF INVENTION

U.S. Pat. No. 7,124,864, issued Oct. 24, 2006, describes a quick release socket connector for use with gas springs. This design may suffer failure when sufficient force is applied to the gas spring or the connector causing the gas spring to unintentionally separate from the connector.

### SUMMARY OF INVENTION

Gas springs or gas lift struts are commonly used with a lid, hatch, hood, cover, door, etc. on a cabinet, trunk or engine area of an automobile, bench, truck bed, dock box, storage locker, etc. The gas springs may assist in lifting and retaining the lid, hatch, hood, cover, door, etc. In certain instances, the user may desire to disconnect the gas spring from the respective articles to achieve full access to the cabinet, trunk or engine area of an automobile, bench, truck bed, dock box, storage locker, etc. For example, in the case of a truck bed cover, the user may wish to wholly remove the truck bed cover such that a large article may better fit into the truck bed. The user may later easily and readily reconnect the gas springs with the present end fittings or connectors.

An end fitting for a gas spring is described. The end fitting includes a fitting body. The fitting body includes a socket opening, a shaft opening, and a compartment. The end fitting includes a spring. The spring is engaged to the fitting body. The end fitting includes a release lever. The release lever is rotatably engaged to the fitting body. The end fitting includes a threaded insert that is positioned or dropped in the compartment. The gas spring engages the threaded insert through the shaft opening. The socket opening engages a ball connector.

The end fitting of the present disclosure provides a significant improvement in strength versus existing designs. The end fitting is generally suitable for applications where increased stress or force may be applied to the end fitting. For example, the end fitting may be used in automotive applications, such as with truck bed covers.

The end connector of the present disclosure includes a drop-in threaded insert. The end connector of the present disclosure, with the drop-in threaded insert, is easier to manufacture as over molding is avoided, which may interfere with a thread pattern of the over-molded end connector.

The threaded insert may be formed of a material different from a reminder of the end fitting. The threaded insert may be formed of a harder or more durable material than a material forming the end fitting. The threaded insert may be formed from a metal or metal alloy, while the end fitting may be molded from a plastic or other elastomer.

In an aspect, an end fitting for a gas spring is described. The end fitting includes a fitting body. The fitting body includes a socket opening, a shaft opening, and a compartment. A spring is engaged to the fitting body. The spring is configured to move between a relaxed configuration and a biased configuration. A release lever is rotatably engaged to the fitting body. The release lever is configured to bias the spring and move the spring to the biased configuration. The spring includes a first end and second end. The first end and the second end are positioned at the socket opening. The first end and the second end are configured to hold a ball connector in the relaxed configuration of the spring. A threaded insert is positioned in the compartment.

In another aspect, an end fitting for a gas spring is described. The end fitting includes a fitting body. The fitting body includes a socket opening, a shaft opening, and a compartment. A spring is engaged to the fitting body. The spring is configured to move between a relaxed configuration and a biased configuration. The spring includes a first end and second end. The first end and the second end are positioned at the socket opening. The first end and the second end are configured to hold a ball connector in the relaxed configuration of the spring. A threaded insert is positioned in the compartment.

In another aspect, an end fitting for a gas spring is described. The end fitting includes a fitting body. The fitting body includes a socket opening, a shaft opening, and a compartment. A spring is engaged to the fitting body. The spring is configured to move between a relaxed configuration and a biased configuration. A release lever is rotatably engaged to the fitting body. The release lever is configured to bias the spring and move the spring to the biased configuration. The spring includes a first end and second end. The first end and the second end are positioned at the socket opening. The first end and the second end are configured to hold a ball connector in the relaxed configuration of the spring. The compartment includes an interior configured to receive a threaded insert.

In another aspect, a method of manufacturing an end fitting for a gas spring is described. The method includes forming a fitting body, the fitting body includes a socket opening, a shaft opening, and a compartment. The method includes engaging a spring to the fitting body. The spring is configured to move between a relaxed configuration and a biased configuration. The spring includes a first end and second end. The first end and the second end are positioned at the socket opening. The first end and the second end are configured to hold a ball connector in the relaxed configuration of the spring. The method includes inserting a threaded insert into the compartment. The method includes engaging a release lever to the fitting body. The release lever is configured to bias the spring and move the spring to the biased configuration.

### BRIEF DESCRIPTION OF DRAWINGS

FIG. 1 is a perspective view of the gas spring with the end connectors.

FIG. 2 is a perspective view of the end connector engaging the ball.

FIG. 3 is a perspective view of the end connector.

FIG. 4 is an exploded view of the end connector.

FIG. 5 is a perspective view of the end connector.

FIG. 6 is a sectional view of the end connector.

FIG. 7 is a sectional view of the end connector with the threaded insert ready for installation.

FIG. 8 is a sectional view of the end connector.

FIG. 9 is a perspective view of the fitting body of the end connector.

### DETAILED DESCRIPTION OF INVENTION

An end fitting 50 for a gas spring 60 is described. The end fitting 50 may be used to quickly and conveniently disconnect the gas spring 60 from a lid, hatch, hood, cover, door, etc. and a corresponding cabinet, trunk or engine area of an automobile, bench, truck bed, dock box, storage locker, etc.

The gas spring 60 commonly includes a rod 70 that extends from a tube 72. The gas spring 60 may provide lifting and/or holding assistance for the lid, hatch, hood, cover, door, etc.

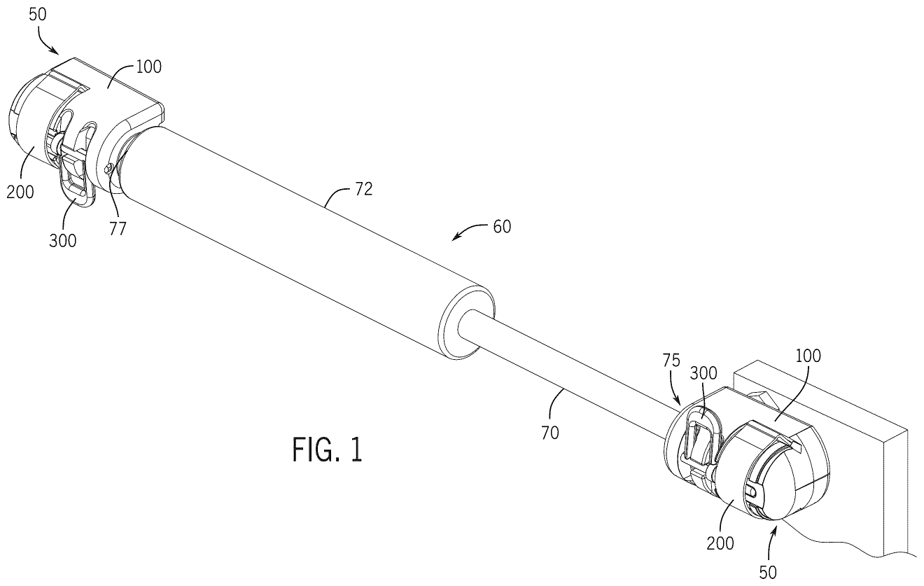

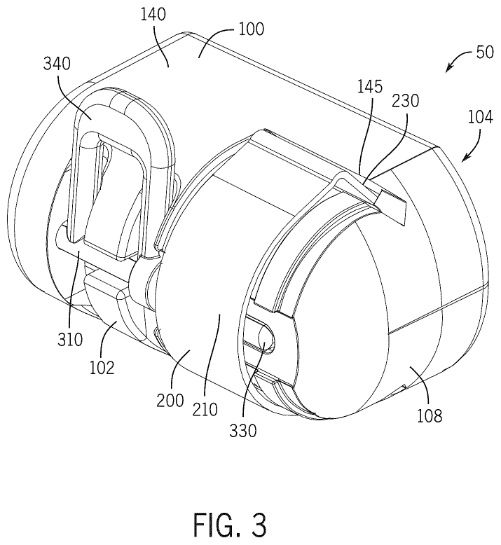

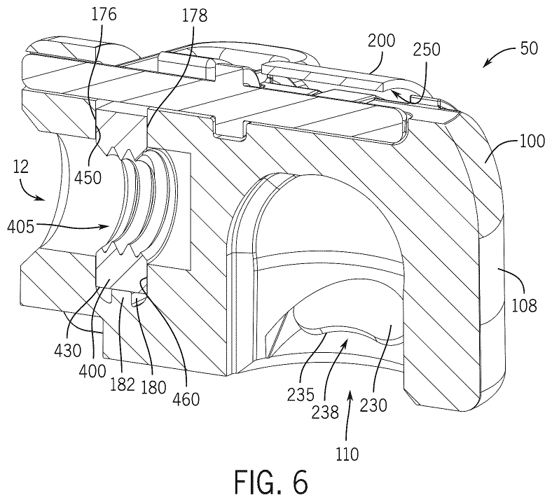

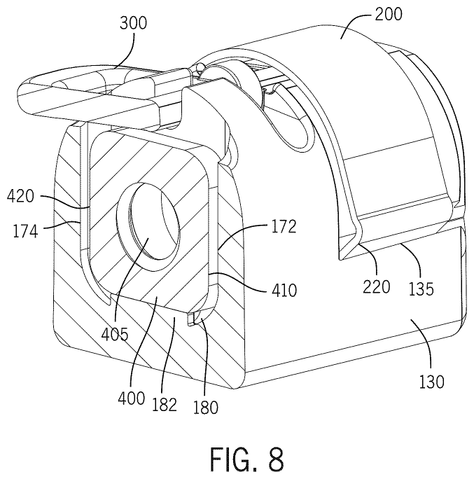

In the aspects of FIGS. 1-9, the rod 70 includes a first threaded end 75, and the tube 72 includes a second threaded end 77. As described below, the first threaded end 75 is configured to engage the end fitting 50, and the second threaded end 77 is configured to engage a second end fitting 50. Of course, in other aspects, the gas spring 60 may only include a single threaded end, and a single end fitting 50 is utilized.

The end fitting 50 comprises a fitting body 100, a spring 200, a release lever 300 and a threaded insert 400. An upper surface 102 of the fitting body 100 includes an opening 168 leading to a compartment 170. The compartment 170 is sized and shaped to receive and hold the threaded insert 400. The fitting body 100 holds the release lever 300 in a rotatable engagement. The release lever 300 is movable to bias the spring 200. As described below, the spring 200 is configured to hold a ball connector 82 in a “ball and socket” fashion. The ball connector 82 may be mounted or incorporated with the lid, hatch, hood, cover, door, etc. and/or the corresponding cabinet, trunk or engine area of an automobile, bench, truck bed, dock box, storage locker, etc. In other aspects, as described below, the end fitting 50 may be provided without the release lever 300.

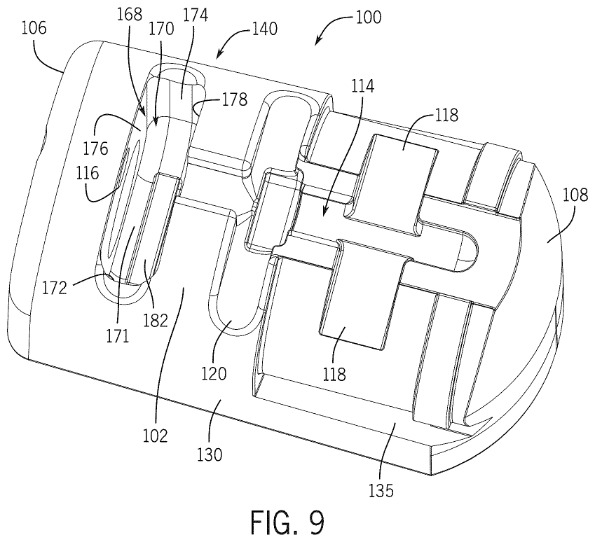

The fitting body 100 will now be described with reference to FIG. 9. The fitting body 100 includes an upper surface 102, a lower surface 104 that is generally opposite of the upper surface 102, a first end surface 106, and a second end surface 108 that is generally opposite of the first end surface 106. The fitting body 100 further includes a first lateral surface 130 that is generally opposite of a second lateral surface 140.

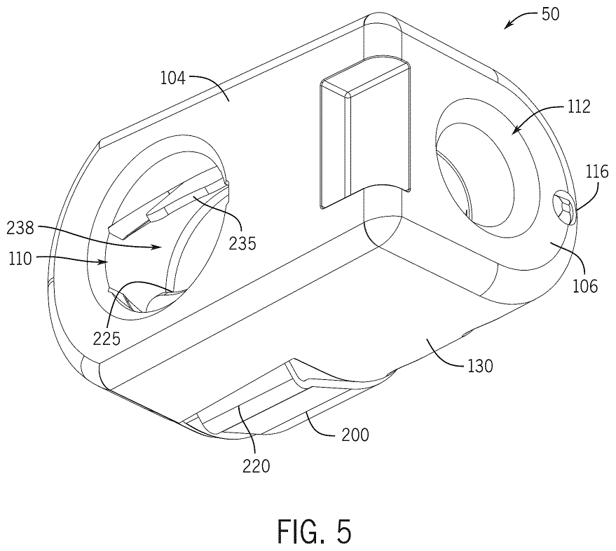

In this aspect, with reference to FIG. 5, a socket opening 110 is formed in the lower surface 104. In this aspect, a shaft opening 112 formed in the first end surface 106. In this aspect, the socket opening 110 is generally perpendicular to the shaft opening 112. In other aspects, the socket opening 110 and the shaft opening 112 may be positioned in different angles or arranged in a linear fashion.

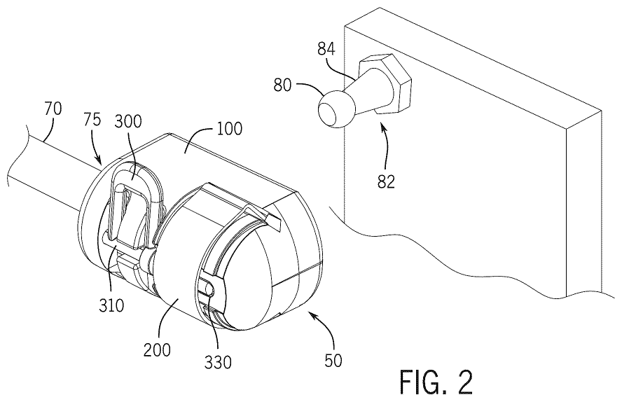

With respect to FIGS. 2 and 5, the socket opening 110 is configured to receive and hold a ball portion 80 of the ball connector 82. The ball portion 80 is connected to the ball connector 82 via a connecting portion 84. The ball portion 80 includes a wider diameter than the connecting portion 84. The ball connector 82 may be attached to or part of the lid, hatch, hood, cover, door, etc. and/or also attached to the corresponding cabinet, trunk or engine area of an automobile, bench, truck bed, dock box, storage locker. etc. The end fittings 50 provide a quick disconnect from the ball connector 82, such that, for example, the lid may be wholly separated from the cabinet.

With respect to FIGS. 2, 5, and 6, the shaft opening 112 is configured to receive the first threaded end 75 of the rod 70 or the second threaded end 77 of the tube 72. The shaft opening 112 leads to the threaded opening 405 of the threaded insert 400, which is positioned in the shaft opening 112. The shaft opening 112 does not require threading, as the threaded insert 400 provides the threading for engagement with the first threaded end 75 or the second threaded end 77. Typically, the first threaded end 75 or the second threaded end 77 is inserted into the shaft opening 112 and further to the threaded opening 405, where the first threaded end 75 or the second threaded end 77 is rotated to threadably engage to the threaded opening 405.

The fitting body 100 further includes the compartment 170 that is configured to receive the threaded insert 400. The compartment 170 includes partially hollow interior 171 sized and shaped to receive the threaded insert 400. The compartment 170 is partially defined by a first lateral inner wall 172 and a second lateral inner wall 174. The compartment 170 is further partially defined by a forward inner wall 176 and a rear inner wall 178. In certain aspects, a bottom surface 180 of the compartment 170 includes a positioner 182. As described below, the positioner 182 assists the threaded insert 400 to seat or position in the correct location in the compartment 170.

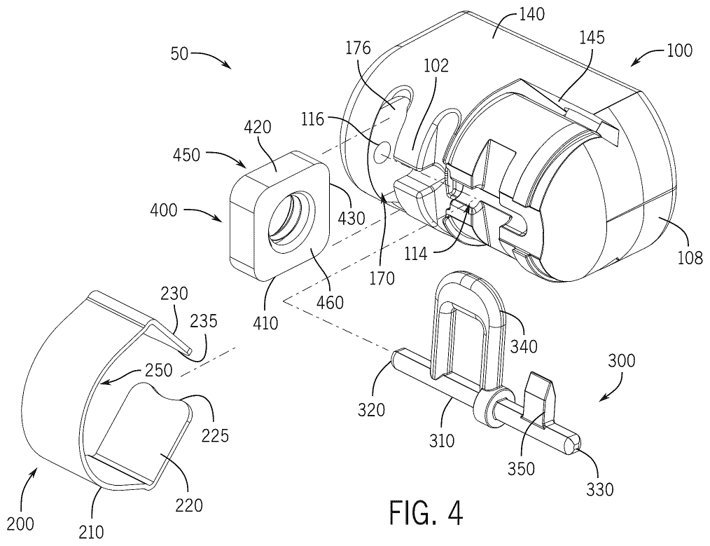

The spring 200 will now be described with reference to FIGS. 4 and 5. The spring 200 includes a curved shaped body 210 with a first end 220 and second end 230. The first end 220 includes an edge 225, and the second end 230 includes an edge 235. The edges 225 and 235 form a ball opening 238 inside of the of socket opening 110 configured to hold and release the ball connector 82. The spring 200 is configured to move between a relaxed configuration and a biased configuration. In the relaxed configuration of the spring 200, the edges 225 and 235 are closer together and the ball opening 238 between the edges 225 and 235 is smaller. In the biased configuration of the spring 200, the edges 225 and 235 are further apart and the ball opening 238 between the edges 225 and 235 is larger.

The spring 200 includes an inner surface 250. When the release lever 300 is rotated, the tab portion 350 pushes against the inner surface 250, which urges the spring 200 to the biased configuration, which moves the edges 225 and 235 further apart. When the tab portion 350 pushes against the inner surface 250 of the spring 200, a central portion of the spring 200 is pushed away from the upper surface 102 of the fitting body 100, which ultimately retracts the edges 225 and 235 and makes the ball opening 238 larger such that the ball portion 80 may pass between the edges 225 and 235.

When the edges 225 and 235 move sufficiently apart, the ball portion 80 may pass through the ball opening 238, and the end fitting 50 may be pulled from ball connector 82. In the relaxed configuration of the spring 200, the edges 225 and 235 are closer together and the ball opening 238 is smaller than a diameter of the ball portion 80 such that the ball portion 80 is held in the socket opening 110. In the biased configuration of the spring 200, the edges 225 and 235 are further apart and the ball opening 238 is larger than a diameter of the ball portion 80 such that the ball portion 80 may pass through the ball opening 238.

The spring 200 includes the curved shaped body 210 with the first end 220 and the second end 230. The spring 200 rests over the upper surface 102 of the fitting body 100. The first lateral surface 130 of the fitting body 100 includes an opening 135, and the second lateral surface 140 of the fitting body 100 includes an opening 145. The first end 220 passes through the opening 135 into the socket opening 110, and, likewise, the second end 230 passes through the opening 145 into the socket opening 110.

The release lever 300 will now be described with reference to FIG. 4. The release lever 300 is rotatably mounted to the fitting body 100. The release lever 300 includes a shaft 310. The shaft 310 includes a first end 320 and a second end 330. The shaft 310 includes a handle portion 340. The handle portion 340 extends generally perpendicular to an axis of rotation of the shaft 310. The shaft 310 includes a tab portion 350. The tab portion 350 also extends generally perpendicular to the axis of rotation of the shaft 310.

The shaft 310 is rotatably fitted in an upper groove 114 of the upper surface 102 of the fitting body 100. The first end 320 of the shaft 310 is held in an opening 116 proximate the first end surface 106 of the fitting body 100. The opening 116 is colinear with the upper groove 114. The upper surface 102 further includes tab indents 118 that are sized and shaped to receive the tab portion 350. The upper surface 102 further includes a handle indent 120 that is sized and shaped to receive the handle portion 340.

The release lever 300 is further positioned over the threaded insert 400. The release lever 300 may assist in holding the threaded insert 400 in the compartment 170.

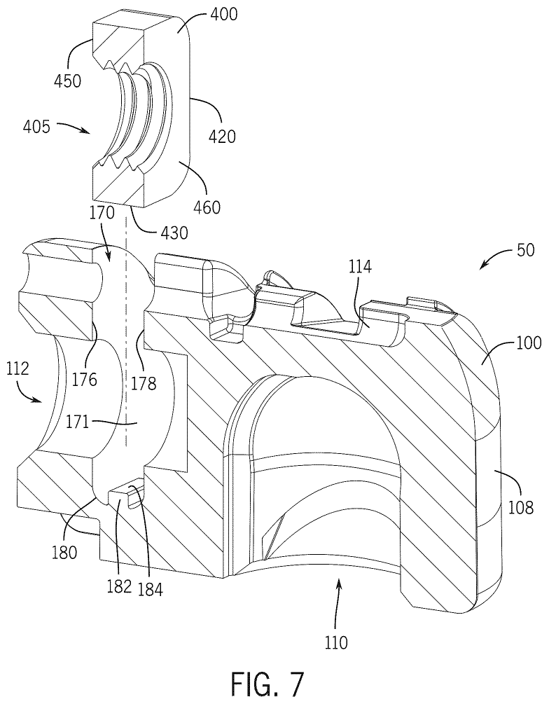

The threaded insert 400 will now be described with reference to FIGS. 4 and 7. The threaded insert 400 includes a threaded opening 405 to threadably receive the first threaded end 75 of the rod 70 or the second threaded end 77 of the tube 72. The threaded insert 400 may be formed from a metal or metal alloy, which is typically much stronger than a plastic of polymeric material forming the fitting body 100.

The threaded insert 400 includes a first lateral wall 410 generally opposite of a second lateral wall 420. The first and second lateral walls 410 and 420 have or form a generally straight or linear outer surface. When the threaded insert 400 is installed or seated in the compartment 170, the first and second lateral walls 410 and 420 are generally flush against or contact the first lateral inner wall 172 and the second lateral inner wall 174 of the compartment 170. The first lateral inner wall 172 and the second lateral inner wall 174 also have a generally straight or linear surface. Thus, the first lateral inner wall 172 and the second lateral inner wall 174 generally prevent the threaded insert 400 from rotating when the threaded insert 400 is installed or seated in compartment 170. In certain aspects, portions of the first lateral inner wall 172 and the second lateral inner wall 174 includes a generally straight or linear surface sufficient to inhibit the rotation or movement of the threaded insert 400.

Further, when the threaded insert 400 is installed in the compartment 170, a forward face 450 of the threaded insert 400 is against the forward inner wall 176 of the compartment 170, and a rear face 460 of the threaded insert 400 is against the rear inner wall 178 of the compartment 170. This assists in dispersing forces applied to the fitting body 100 throughout the fitting body 100.

In the aspect of FIGS. 1-9, the threaded insert 400 includes a square or a generally rectangular shape. The square or generally rectangular shape of the threaded insert 400 fits into the partially hollow interior 171 of the compartment 170. The partially hollow interior 171 may form a box shape with a rectangular or a cuboid form that receives the threaded insert 400. The partially hollow interior 171 may be just larger than the threaded insert 400 such that the threaded insert 400 fits into the partially hollow interior 171, and the first lateral inner wall 172 and the second lateral inner wall 174 prevent the threaded insert 400 from rotating in the compartment 170. In other aspects, the threaded insert 400 may include a wedge shape or other shape.

The positioner 182 assists the threaded insert 400 to seat or position in the correct location in the compartment 170. The positioner 182 assists the threaded insert 400 to seat or position flush against the compartment 170 in a non-crooked manner. The positioner 182 includes a generally flat upper surface 184 that receives the bottom wall 430 of the threaded insert 400. The positioner 182 further slightly elevates the threaded insert 400 from the bottom surface 180 of the compartment 170 such that that threaded insert 400 is not directly contacting a bottom corner of the compartment 170, where the fitting body 100 may be weaker. This provides added strength to the end fitting 50.

In other aspects, the compartment 170 may be formed in a bottom or lateral surface of the fitting body 100.

In other aspects of the end fitting 50, the release lever 300 may be omitted from the end fitting 50. For example, a separate tool may be used to open the edges 225 and 235 of the spring 200 and make the ball opening 238 larger such the ball portion 80 may pass through the ball opening 238. For example, a user with a flat head screwdriver may pry against the spring 200 or directly against the edges 225 and 235 in order to retract the edges 225 and 235 and makes the ball opening 238 larger such that the ball portion 80 may pass through the ball opening 238.

As such, it should be understood that the disclosure is not limited to the particular aspects described herein, but that various changes and modifications may be made without departing from the spirit and scope of this novel concept as defined by the following claims. Further, many other advantages of applicant's disclosure will be apparent to those skilled in the art from the above descriptions and the claims below.

What is claimed is:

1. An end fitting for a gas spring, comprising:
a fitting body, the fitting body comprising a socket opening, a shaft opening, and a compartment;
a spring, the spring engaged to the fitting body, the spring is configured to move between a relaxed configuration and a biased configuration;
a release lever, the release lever rotatably engaged to the fitting body, the release lever is configured to bias the spring and move the spring to the biased configuration;
the spring comprising a first end and second end, the first end and the second end are positioned at the socket opening, the first end and the second end are configured to hold a ball connector in the relaxed configuration of the spring; and
a threaded insert positioned in the compartment.

2. The end fitting for the gas spring according to claim 1, the first end includes a first edge, and the second end includes a second edge, the first and second edges define a ball opening inside of the socket opening that is configured to hold and release a ball of the ball connector.

3. The end fitting for the gas spring according to claim 2, wherein in the relaxed configuration of the spring, the first edge and the second edge are closer together and the ball opening is smaller than when the spring is in the biased configuration.

4. The end fitting for the gas spring according to claim 1, wherein the shaft opening leads to a threaded opening of the threaded insert.

5. The end fitting for the gas spring according to claim 1, wherein the compartment includes an interior sized and shaped to receive the threaded insert, wherein the release lever is positioned over the compartment and the threaded insert.

6. The end fitting for the gas spring according to claim 1, wherein the threaded insert includes a square or a generally rectangular shape, and an interior of the compartment includes a box shape with a rectangular or a cuboid form.

7. The end fitting for the gas spring according to claim 1, wherein the compartment includes a first lateral inner wall and a second lateral inner wall, wherein the first lateral inner wall and the second lateral inner wall include a generally straight or linear surface, wherein the threaded insert includes a first lateral wall and a second lateral wall, the first and second lateral walls include a generally straight or linear outer surface.

8. The end fitting for the gas spring according to claim 7, wherein the first and second lateral walls of the threaded insert are generally flush against or contact the first lateral inner wall and the second lateral inner wall of the compartment.

9. The end fitting for the gas spring according to claim 8, wherein the first lateral inner wall and the second lateral inner wall of the compartment prevent the threaded insert from rotating.

10. The end fitting for the gas spring according to claim 1, wherein the compartment is partially defined by a first lateral inner wall, a second lateral inner wall, a forward inner wall, and a rear inner wall.

11. The end fitting for the gas spring according to claim 1, wherein the compartment includes a positioner.

12. The end fitting for the gas spring according to claim 11, wherein the positioner assists the threaded insert to seat or position in the compartment.

13. The end fitting for the gas spring according to claim 11, wherein the positioner includes a generally flat upper surface that receives a bottom wall of the threaded insert.

14. The end fitting for the gas spring according to claim 11, wherein the positioner elevates the threaded insert from a bottom surface of the compartment.

15. The end fitting for the gas spring according to claim 1, wherein the compartment includes a bottom surface, and the bottom surface includes a positioner, and the positioner extends from the bottom surface.

16. An end fitting for a gas spring, comprising:
a fitting body, the fitting body comprising a socket opening, a shaft opening, and a compartment;
a spring, the spring engaged to the fitting body, the spring is configured to move between a relaxed configuration and a biased configuration;
a release lever, the release lever rotatably engaged to the fitting body, the release lever is configured to bias the spring and move the spring to the biased configuration;
the spring comprising a first end and second end, the first end and the second end are positioned at the socket opening, the first end and the second end are configured to hold a ball connector in the relaxed configuration of the spring; and
wherein the compartment includes an interior that is configured to receive a threaded insert.

17. The end fitting for the gas spring according to claim 16, wherein the threaded insert is positioned in the compartment.

18. An end fitting for a gas spring, comprising:
a fitting body, the fitting body comprising a socket opening, a shaft opening, and a compartment;
a spring, the spring engaged to the fitting body, the spring is configured to move between a relaxed configuration and a biased configuration;
the spring comprising a first end and second end, the first end and the second end are positioned at the socket opening, the first end and the second end are configured to hold a ball connector in the relaxed configuration of the spring; and
a threaded insert positioned in the compartment.

19. A method of manufacturing an end fitting for a gas spring, comprising:
forming a fitting body, the fitting body comprising a socket opening, a shaft opening, and a compartment;
engaging a spring to the fitting body, the spring is configured to move between a relaxed configuration and a biased configuration, the spring comprising a first end and second end, the first end and the second end are positioned at the socket opening, the first end and the second end are configured to hold a ball connector in the relaxed configuration of the spring;
inserting a threaded insert into the compartment; and
engaging a release lever to the fitting body, the release lever is configured to bias the spring and move the spring to the biased configuration.

20. The method of manufacturing an end fitting for a gas spring according to claim 19, further comprising engaging the release lever to the fitting body over the compartment.

21. The method of manufacturing an end fitting for a gas spring according to claim 19, further comprising forming a positioner in a bottom of the compartment.

22. The method of manufacturing an end fitting for a gas spring according to claim 19, further comprising inserting the threaded insert into the compartment and seating the threaded insert against a positioner in a bottom of the compartment.
